(19) United States
(12) Patent Application Publication
(10) Pub. No.: US 2009/0327889 A1
(43) Pub. Date: Dec. 31, 2009

(54) MATRIX BLOGGING SYSTEM AND SERVICE SUPPORTING METHOD THEREOF

(76) Inventors: Eui-heon JEONG, Suwon-si (KR); Yeong-geol KIM, Yongin-si (KR)

Correspondence Address: North Star Intellectual Property Law, PC, P.O. Box 34688, Washington DC, DC, 20043, US

(21) Appl. No.: 12/492,317

(22) Filed: Jun. 26, 2009

(30) Foreign Application Priority Data
Jun. 30, 2008 (KR) 10-2008-0062775

(51) Int. Cl. G06F 3/048; G06F 17/30

(52) U.S. Cl. 715/706; 707/3; 707/E17.108

(57) ABSTRACT

A matrix blogging system and a service supporting method thereof are provided. In a virtual world generated by mapping a real world in a predetermined form, a virtual avatar corresponding to a fixed terminal and a real avatar corresponding to a mobile terminal are operated, and a facial expression, a status, a movement, and a direction of the real avatar are changed in real time based on tag information collected by the mobile terminal, and a blog or contents that is searched for with high reliability and accuracy based on the collected tag information is provided to a user of the mobile terminal.

### CROSS REFERENCE TO RELATED APPLICATION(S)

This application claims the benefit under 35 U.S.C. § 119(a) of a Korean Patent Application No. 10-2008-0062775, filed on Jun. 30, 2008, the disclosure of which is incorporated herein in its entirety by reference for all purposes.

### BACKGROUND

1. Field

The following description relates to a matrix blogging system and a service support method thereof.

2. Description of the Related Art

With the development of three dimensional (3D) technologies, a 3D virtual world, which had previously been considered as a fictional world only realized in movies or novels, is more widely available in the real life. Second Life and Google Earth are the recent successful and direct examples of the 3D virtual world in a World Wide Web environment. It is likely that the 3D Web will play a leading role for 3D virtual world technologies.

Blogs in association with the second generation of web development and design (called Web 2.0) encourage establishing social networks and communities on the web based on the characteristics of the Web 2.0, i.e., participation, sharing, and openness, lead the usual consumers to evolve into prosumers, who are consumers taking part in the production process, and cresumers, who are creative consumers influencing manufacturers and retailers, as well as other consumers. Consequently, the simple contents of a one-person media such as user created contents (UCC) have been developed beyond amateurism to a more professional customized UCC, i.e., into professional creative contents (PCC).

Conventionally, blog services use a traditional data search method of extracting keywords from contents by automatic indexing so as to provide appropriate contents created by particular users to other users. In such blogging services, blog users can be enabled to assign a tag, which is metadata indicating a category of information, to the contents, and improvement of the accuracy of customized information can be accomplished based on locations such as geo-tags, by utilizing the Digital Earth technology.

### SUMMARY

In one general aspect, a matrix blogging service is operated by accessing, by a user terminal, a blogging server; creating, at the blogging server, an avatar corresponding to the user terminal; operating, at the blogging server, a virtual matrix space including applying the avatar to a mirror world corresponding to a real world where the user terminal is located; receiving, at the blogging server, tag information from the user terminal; extracting, at the blogging server, tags including a status, mobility and a direction of the avatar based on the tag information; and transmitting, at the blogging server, image information corresponding to the virtual matrix space including the avatar to which the tags are applied to the user terminal.

Implementations may include one or more of the following features. For example, the user terminal may be at least one of a mobile terminal and a fixed terminal. The avatar may be created by creating a virtual avatar corresponding to the fixed terminal and/or creating a real avatar corresponding to the mobile terminal. The virtual matrix space may be operated by allowing at least one of the real avatar and the virtual avatar to enter the mirror world; and operating the entered real avatar or the entered virtual avatar.

The image information may be transmitted to the user terminal by verifying a device profile of the user terminal; converting the image information based on conditions of a user interface outputting the image information and the amount and speed of data receivable by the user terminal according to the device profile; and transmitting the converted image information to the user terminal. The image information may be transmitted to the user terminal by checking data processing capability of a communication network between the blogging server and the user terminal; and converting the image information according to the data processing capability.

The tag information may be received by receiving profile tag information including at least one of the age, gender, date of birth, and nationality of the user; receiving situation tag information including at least one of a location and emotion of the user and temperature and humidity around the user terminal; and/or receiving preference tag information including at least one of music, a trip, a pet, food, dramas, sports, fashion, politics, and a school. Information regarding at least one of a blog or contents to be recommended to the avatar may be searching for based on at least one of the profile tag information, the situation tag information, and the preference tag information. Moreover, the avatar may be provided with at least one of the searched information and tags extracted from at least one of the profile tag information, the situation tag information and the preference tag information. The information may be searched for by extracting, at the blogging server, an index term from at least one of the profile tag information, the situation tag information, and the preference tag information; and searching for at least one of a blog information and the contents information that matches the extracted index term from a database in which at least one blog and at least one contents are classified based on index terms. A voice or text query may be received from the user terminal; an index term may be extracted from the voice or text query; and at least one of the blog and the contents may be searched for using the index term extracted from the audio or text query.

In another general aspect, a matrix blogging system includes a user terminal configured to access a blogging server through a communication network, collect tag information, and transmit the tag information to a blogging server. The blogging server is configured to create an avatar corresponding to the user terminal, operate a virtual matrix space by applying the avatar to a mirror world corresponding to a real world where the user terminal is located, extract tags including at least one of a status, mobility and a direction of the avatar from tag information received from the user terminal to apply the tags to the avatar, and transmit image information corresponding to the virtual matrix space including the avatar, to which the tags are applied, to the user terminal.

Implementations may include one or more of the following features. For example, the user terminal may be at least one of a fixed terminal and a mobile terminal and the blogging server may be configured to create at least one of a virtual avatar corresponding to the fixed terminal and a real avatar corresponding to the mobile terminal.

The blogging server may include a device profile unit configured to verify a device profile of the user terminal; a contents converting unit configured to convert the image information based on conditions of a user interface outputting the image information and the amount and speed of data receivable by the user terminal according to the device profile; and a data synchronizing unit configured to transmit the converted image information to the user terminal.

The user terminal may collect at least one of profile tag information, situation tag information and preference tag information. The profile tag information indicates a unique background factor of the user terminal and includes at least one of the age, the gender, the date of birth, and the nationality of the user. The situation tag information can be changed according to a situation which the user faces and includes at least one of a location and emotion of the user and temperature and humidity around the user terminal. The preference tag information is independent of the time and location of the user terminal, and includes at least one of music, a trip, a pet, food, dramas, sports, fashion, politics, and a school.

The blogging server may include a virtual matrix space managing server configured to search for information regarding at least one of a blog or contents to be recommended to the avatar based on at least one of the profile tag information, the situation tag information, and the preference tag information; and provide the avatar with at least one of the searched information and tags extracted from at least one of the profile tag information, the situation tag information, and the preference tag information. The virtual matrix space managing server includes a real object tracker configured to extract an index term from at least one of the profile tag information, the situation tag information, and the preference tag information; and a blog connector configured to search for at least one of the blog information and the contents information that corresponds to the extracted index term from a database classifying at least one blog and at least one contents by an index term. The virtual matrix space managing server may also include an audio collector configured to receive an audio or text query from the user terminal and extract an index term from the audio or text query and the blog connector searches for at least one of the blog and the contents using the index term extracted from the audio or text query.

Accordingly, in one aspect, there is provided a matrix blogging system and method for supporting a virtual matrix blogging space to provide a user-friendly and immediate service.

According to an aspect, there is provided a matrix blogging system including a user terminal and a blogging server.

The user terminal accesses a blogging server through a communication network, collects tag information and transmits the tag information to the blogging server. The blogging server creates an avatar corresponding to the user terminal, operates a virtual matrix space by applying the avatar to a mirror world corresponding to a real world where the user terminal is located, extracts tags including at least one of a status, mobility and a direction of the avatar from tag information received from the user terminal to apply the tags to the avatar, and transmits image information corresponding to the virtual matrix space including the avatar, to which the tags are applied, to the user terminal.

According to another aspect, there is provided a matrix blogging service supporting method including accessing, by a user terminal, a blogging server, creating at the blogging server an avatar corresponding to the user terminal, operating, at the blogging server, a virtual matrix space by applying the avatar to a mirror world corresponding to a real world where the user terminal is located, receiving tag information by the blogging server from the user terminal, extracting, at the blogging server, tags including a status, mobility and a direction of the avatar based on the tag information, transmitting image information corresponding to the virtual matrix space including the avatar to which the tags are applied from the blogging server to the user terminal.

In the matrix blogging system and the service providing method of the matrix blogging system, information regarding a user who is present in a physical real world is possible to be represented in a virtual matrix space that matches the real world, and various items of information regarding a region where the user is located are provided for the user to use immediately and broadly.

Other features and aspects will be apparent from the following detailed description, the drawings, and the claims.

### BRIEF DESCRIPTION OF THE DRAWINGS

FIG. 1 is an illustration for explaining an exemplary virtual matrix space.

FIG. 2 is a block diagram illustrating an exemplary configuration of a matrix blogging system for supporting a virtual matrix space.

FIG. 3 is a tree diagram of a tag classification of the mobile terminal of FIG. 2.

FIG. 4 is a block diagram showing exemplary procedures of converting information at a blogging server.

FIG. 5 is block diagram showing an exemplary configuration of a blogging server.

FIG. 6 is a block diagram illustrating an exemplary configuration of a virtual matrix space managing server.

FIG. 7 is a block diagram illustrating an exemplary fixed terminal.

FIG. 8 is a block diagram illustrating an exemplary mobile terminal.

FIG. 9 is a diagram illustrating an exemplary signal flow for explaining a matrix blogging service supporting method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves those of ordinary skill in the art. Descriptions of well-known functions and structures are omitted to enhance clarity and conciseness.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a system will be described that supports a mirror world that reflects the real world intact and a virtual matrix space created by mapping objects of real life on the mirror world, and allows bloggers to create and tag their own contents easily using a mobile terminal and share the contents with other bloggers in the mirror world and the virtual matrix space. Accordingly, a more interesting and productive service is available by overcoming obstacles caused by distinguishing the mirror world and the real life in an advanced two-dimensional (2D) or three-dimensional (3D) virtual matrix space. To provide accurate customized contents, an intelligent service is provided to utilize a context aware function of a device with mobility, thereby developing a long-tail business by bloggers.

Hereinafter, tag information refers to information generated by assigning indexes or information in a predetermined form to various types of information that a mobile terminal user inputs or a context sensor collects, and such information may include situation information, preference information and profile information of the mobile terminal user.

The mirror world is a world nearly or exactly identical to the real world, and is constructed based on a 2D or 3D blueprint of a particular area. More specifically, when a mirror world for a particular district of Seoul, for example, Yeouido, is constructed, various landmarks and actual objects represented on a map, such as the Han-river, various kinds of trees planted in Yeouido Park, roads around Yeouido Park, buildings surrounding the roads, neighborhood facilities located across the riverside of the Han-river, and sightseeing boats sailing up and down the Han-river, are placed in a virtual space such that each object corresponds to the actual object in real life to create a miniature of Yeouido based on the real world. Accordingly, the mirror world may be exactly the same as the real life with respect of its physical features, roads, and buildings.

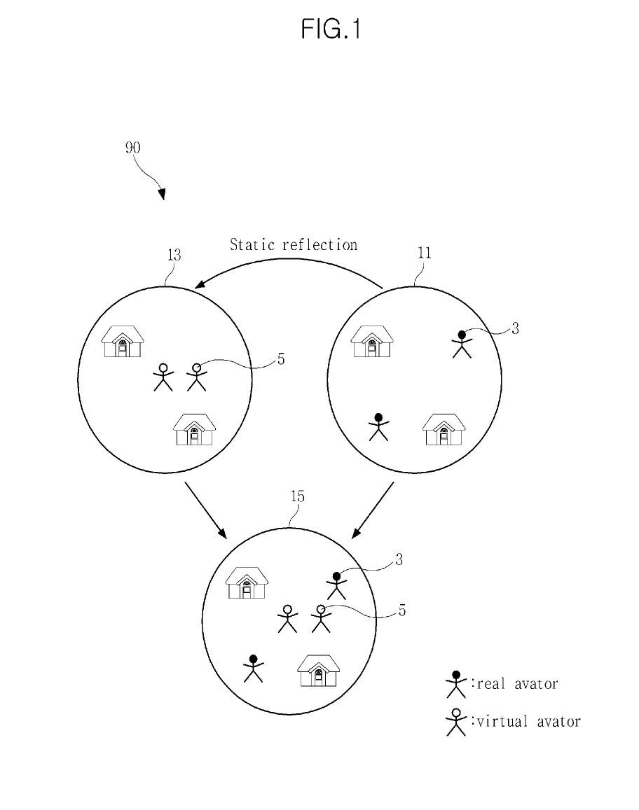

FIG. 1 is an illustration for explaining an exemplary virtual matrix space 15. Referring to FIG. 1, the virtual matrix space 15 is a world in which two different structures, i.e., a real world 11 and a mirror world 13, are combined together. Avatars belonging to the virtual matrix space 15 may be divided into virtual avatars 5 and real avatars 3 according to the relationship between the avatar and a user of a terminal in the real world 11, and a range of functions of the avatar. Each avatar represents a user or a terminal. Each virtual avatar 5 may be passive, unilateral, dependent, and unintelligent, carrying out communications and changing its appearance, presence and location in response to a user command. Each real avatar 3 refers to an active, positive, and intelligent avatar that interacts with a user to decide its own actions to take, location where to be, and emotion to express, not only by the user control, but by tracing or inferring physical appearance and presence of the user that the avatar represents and the physical environment surrounding the user.

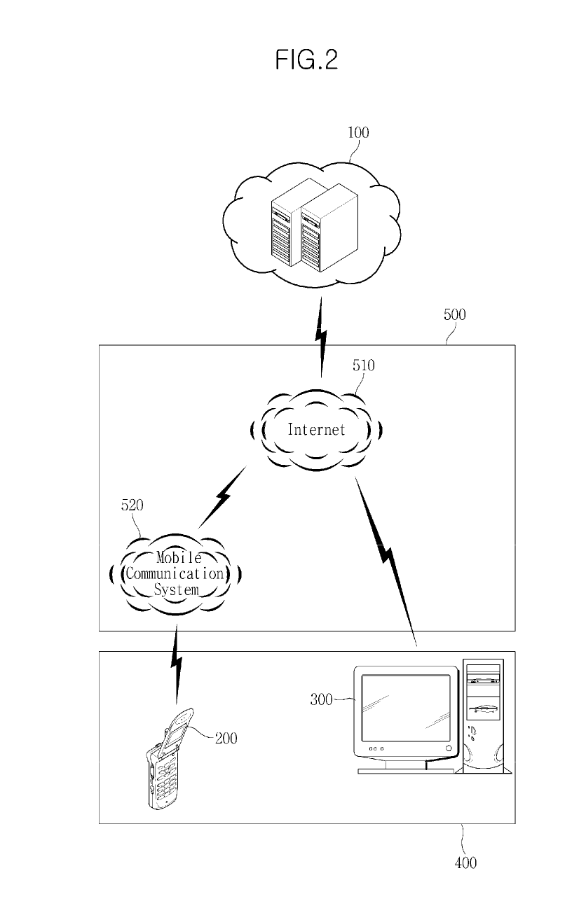

The virtual matrix space 15 is a 2D or 3D virtual world and enables the mirror world 13 to be run while reflecting real-time information from a mobile terminal through the real avatars 3 considered as the bridge to the mirror world 13. The real-time information includes movements, emotions and locations of users of mobile terminals in the real world 11, and temperature and humidity of the real world 11, and is tracked in real time to be reflected to the mirror world 13 that reflects the real world 11. Furthermore, the virtual matrix space 15 may include a virtual avatar 5 corresponding to a fixed terminal such as a desktop computer, as well as the real avatar 3 corresponding to the mobile terminal. In other words, the virtual matrix space 15 statically reflects landmarks of the real world 11 into an avatar-oriented 2D or 3D mirror world, thereby realizing the reflection of spatial and static aspects of the real world 11. Also, the virtual matrix space 15 dynamically reflects the environment and surroundings of a user in the real world 11 using the real avatars 3 and the virtual avatars 5. In this case, the virtual avatar 5, which has information corresponding to the fixed terminal, is operated within a limited range of area, compared to a mobile terminal, and thus may tend to have static reflection information more than dynamic reflection information. However, the virtual avatar 5 may be implemented to access or move in the virtual matrix space 15 of various forms provided by a blogging server (shown in FIG. 2) in response to an input signal from the fixed terminal, so that the virtual avatar 5 may have dynamic reflection information comparable to that of the real avatar 3. Hereinafter, it will be described a case where the real avatar 3 with the dynamic reflection information is operated in the virtual matrix space 15. However, in some cases, the virtual avatar 5 may be possible to be operated with dynamic reflection information in the virtual matrix space 15 in the similar manner as the real avatar 3. Accordingly, the user may experience more improved reality in the virtual matrix space, compared to the mirror world 13, through the static and dynamic reflection, and the each item of information of the real world 11 may be used as a tag constructing the virtual matrix space to provide customized information to the user.

FIG. 2 is a view illustrating a configuration of an exemplary matrix blogging system 90 for supporting a virtual matrix space 15. Referring to FIG. 2, the matrix blogging system 90 includes a blogging server 100, a user terminal 400, and a communication network 500.

The blogging server 100 may be a computer, computing system, or device on the network 500 that manages resources of the network 500, and that is configured to share its resources or run applications for the other computers on the network 500. Any user on the network 500 can store files on the blogging server 100. The blogging server 100 may be configured, for example, to manage network traffic, or to process database queries. The blogging server 100 may be dedicated, meaning that it performs no other tasks besides its server tasks. On multiprocessing operating systems, however, a single computer can execute several programs at once. In this case, the blogging server 100 could be the program that is managing resources rather than the entire computer.

The blogging server 100 can be configured to handle file or database sharing between all users on your network 500, or can be configured to allow all users to share a printer, rather than having a printer hooked up to each individual computer in an organization.

The blogging server 100 can be hardware, software, or some combination of hardware and software. That is, the blogging server 100 can be specific software package running on a computer or the computer on which that software is running. The network 500 can be a LAN, a WAN, or the Internet.

A terminal (which is sometimes referred to as a computer terminal) such as the user terminal 400 can be an electronic or electromechanical hardware device that is used for entering data into, and displaying data from, a host computer or a host computing system. The function of a terminal can be confined to display and input of data; though a terminal with significant local programmable data processing capability may be called a “smart terminal” or fat client. A terminal that depends on the host computer for its processing power is called a thin client. A personal computer can run software that emulates the function of a terminal, sometimes allowing concurrent use of local programs and access to a distant terminal host system.

The user terminal 400 includes a mobile terminal 200 having mobility and a fixed terminal 300 having comparatively less mobility. The mobile terminal 200 and the fixed terminal 300 are distinguished according to whether or not a user can carry it. In this case, a hybrid terminal such as a laptop computer that can be carried and fixed may be categorized as either the mobile terminal 200 or the fixed terminal 300. In addition, the matrix blogging system 90 may provide a virtual matrix space using only a plurality of mobile terminals 200.

The matrix blogging system 90 provides a real avatar 3 and a virtual avatar 5 to a mirror world 13 that corresponds to the real world 11 in order to support a virtual matrix space 15. The real avatar 3 corresponds to the mobile terminal 200 and the virtual avatar 5 corresponds to the fixed terminal 300. As a result, the matrix blogging system 90 allows a user in the virtual matrix space 15 to easily obtain various items of information, which are usually difficult to achieve in real life, and to establish and maintain new communities using the real avatar 3 or the virtual avatar 5.

The blogging server 100 provides the virtual matrix space 15 and the avatars 3, 5, which can be operated in the virtual matrix space 15, to the mobile terminal 200 and the fixed terminal 300. For example, the real avatar 3 is provided to the mobile terminal 200, and the virtual avatar 5 is provided to the fixed terminal 300. Additionally, the blogging server 100 provides contents to the virtual matrix space 15. The blogging server 100 may provide a variety of information to the user terminal 400, allowing the user to exploit the virtual matrix space 15 and contents using the user terminal 400, once the user terminal 400 is connected over the communication network 500. That is, the blogging server 100 may provide blog information or contents information corresponding to information (hereinafter, referred to as “static reflection information”) that statically mirrors the real world 11 where the user terminal 400 is actually located. The static reflection information may include landmark information, weather information, temperature information, and the like. Furthermore, the blogging server 100 may receive tag information from the user terminal 400, and support the virtual matrix space 15 to reflect the received tag information to an avatar assigned for the user terminal 400.

More specifically, the blogging server 100 establishes a communication channel between the mobile terminal 200, a communication system 520 and the Internet 510, and pieces of tag information received from the mobile terminal 200 are classified according to predetermined criteria, and a corresponding tag is extracted from the classified tag information. The blogging server 100 determines a motion or a state of the real avatar 3 corresponding to the mobile terminal 200 based on the extracted tag. Also, the blogging server 100 may transmit image information relevant to the contents or blog to the mobile terminal 200 through the communication network 500 such that the virtual matrix space 15, in which the corresponding real avatar 3 is present, various contents available in the virtual matrix space 15 and the real avatar 3 can be displayed on a display portion of the mobile terminal 200. The blogging server 100 may transmit the image information to the fixed terminal 300 as well. Accordingly, each avatar in the virtual matrix space 15 provided by the blogging server 100 may be assigned with static reflection information corresponding to the area where the mobile terminal 200 or the fixed terminal 300 is located or information (hereinafter, referred to as “dynamic reflection information”) to be dynamically reflected, where the dynamic reflection information is obtained from the tag information of the mobile terminal 200. In addition, in the virtual matrix space 15, an index for searching for blogs or contents to be recommended to the user terminal 400 is extracted from the tag information received from the user terminal 400, and the blogs or contents searched based on the extracted index may be provided to the corresponding avatar.

The mobile terminal 200 attempts to access the blogging server 100 through the mobile communication system 520 and/or the Internet 510, and enters the virtual matrix space 15 provided by the blogging server 100 with information corresponding to the real avatar 3. Moreover, the mobile terminal 200 classifies dynamic reflection information, which is collected by operating various devices of the mobile terminal 200, according to tags, and transmits the classified tag information to the blogging server 100. Also, the mobile terminal 200 receives and outputs the contents searched and recommended based on the tag information by the blogging server 100 and information of setting movements or environments of a real avatar 3. Consequently, the mobile terminal user may obtain various contents in real time in the virtual matrix space 15 corresponding to the real world 11 by use of the real avatar 3, which mirrors the mobile terminal user. Furthermore, the mobile terminal user uses the real avatar 3 to mirror the current state of the user into the virtual matrix space 15, so that the mobile terminal user can inform of his/her state to other avatars corresponding to mobile or fixed terminal users and share the same virtual matrix space 15. To this end, the mobile terminal 200 accesses the blogging server 100 to input user information, and then conducts pre-processing for setting up a real avatar 3 similar to the mobile terminal user. Through this pre-processing, the mobile terminal 200 is registered to the blogging server 100 to create the real avatar 3, and enters the virtual matrix space 15 provided by the blogging server 100 using the created real avatar. Then, the mobile terminal 200 collects and transmits the tag information to the blogging server 100 so that the mobile terminal 200 can use contents corresponding to the tag information and output image information of various facial expressions, movements, and gestures of the real avatar 3. The classification of tags will be described later in detail with reference to drawings.

The fixed terminal 300 attempts to access the blogging server 100 through the Internet 510, and uses a virtual avatar 5 to enter the virtual matrix space 15 provided by the blogging server 100. Then, the fixed terminal 300 transmits an input signal to the blogging server 100 using an input device such as a keyboard to conduct various operations including moving the virtual avatar 5 corresponding to the fixed terminal 300 in the virtual matrix space 15, communicating with other avatars audibly or by texts, collecting information in a format of contents from a building or a geometrical feature in the virtual matrix space 15, and creating and registering contents in the virtual matrix space 15.

As described above, the matrix blogging system 90 overcomes the limitation in use of a virtual matrix space 15 based on the virtual avatar 5 corresponding the fixed terminal 300, and provides the mobile terminal 200 and the real avatar 3 for reflecting the location and state of the real user directly and in real time. Accordingly, the matrix blogging system 90 can use the virtual matrix space 15 not only as a virtual space but also as a miniature or recreation of the real world, thereby enabling collection of various contents provided by the blogging server 100 from the virtual matrix space 15. Moreover, the matrix blogging system 90 may support the user terminal 400 to create and register new contents in the virtual matrix space 15 or to exchange information with other avatars corresponding to other user terminals.

Hereinafter, classification of tags of the mobile terminal 200 for operating the matrix blogging system more efficiently will now be described in detail with reference to drawings.

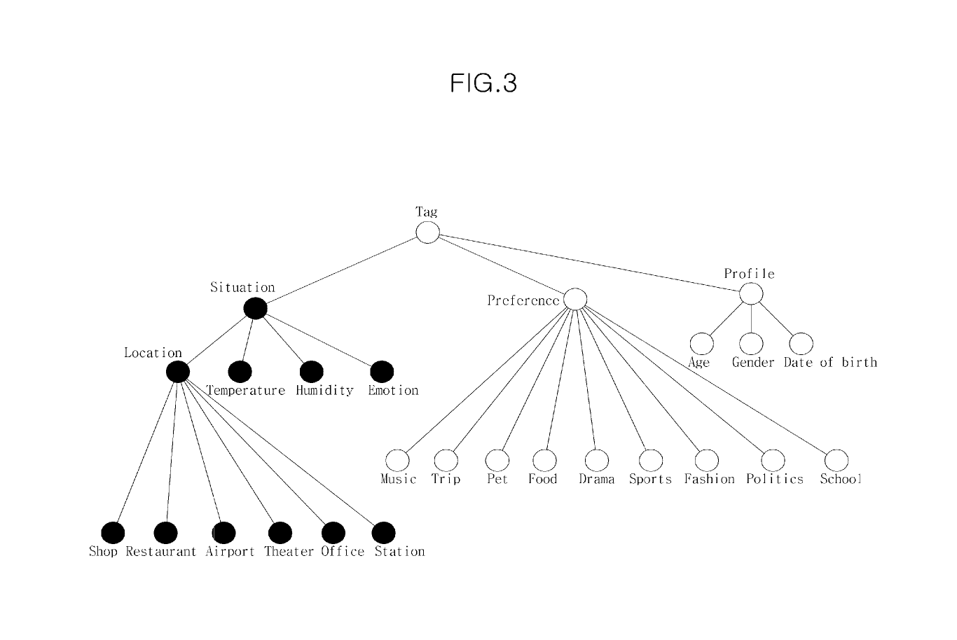

FIG. 3 is a tree diagram of tag classification of the mobile terminal 200 of FIG. 2. Real-time and direct applying of a great amount of information of a mobile terminal user to the real avatar 3 may lead to an exponential increase in operation load of the mobile terminal 200 and the blogging server 100. Hence, appropriate tag classification is implemented for reducing the operation load and moving the real avatar 3 properly in the virtual matrix space 15 based on information classified according to predetermined criteria. By the tag classification, pieces of static reflection information and dynamic reflection information, which are provided by the mobile terminal 200, are classified according to predetermined criteria and classified information is applied to the real avatar 3 in real time in the virtual matrix space 15, thereby allowing use of various contents from the blogging server 100 based on the tag classification.

Referring to FIG. 3, the exemplary tag information includes profile tags, situation tags, and preference tags. The profile tags include, for example, age, gender, date of birth, and nationality. That is, the profile tags indicate unique background factors with respect to a user of the mobile terminal 200. The situation tags include, for example, situational factors such as location, temperature, humidity, and emotion. That is, the situation tags vary easily in real time with the conditions. Each of the subdivided tags, for example, a location tag includes detailed items such as “shop”, “restaurant”, “airport”, “theater”, “office”, and “station”. The preference tags indicate, for example, constant interests of common people such as music, travel, pet, food, theater, cinema, sports, fashion, politics, and school.

Such tag classification is based on an idea that interests of the mobile terminal user may be affected by his/her situation, profile, and preference, and each of the mobile terminal users can be provided with customized and personalized contents based on the tag classification. Accordingly, in an area at which the mobile terminal 200 is located, the user of the mobile terminal 200 tags a particular information and the location of the mobile terminal 200 is automatically reflected, so that a search for contents such as pictures and texts can be supported. Moreover, various devices, e.g., a sensor device, of a terminal with mobility are used to reflect all situational factors around the user, and take into consideration the preference and profile of the user such that a more accurate search for contents to be recommended for each mobile terminal 200 can enable more intelligent and customized contents search. As a result, the exemplary matrix blogging system 90 supports the blogging server 100 to provide a mobile terminal 200 with necessary, useful, or customized information based on pieces of tag information that are collected according to the tag classification and transmitted from the mobile terminal 200 to the blogging server 100.

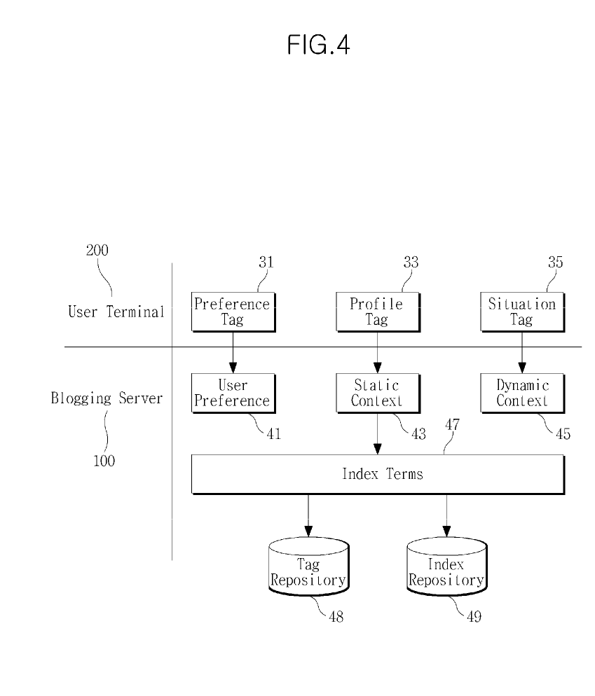

FIG. 4 is a block diagram for explaining procedures of a blogging server 100 to search for contents to recommend or convert the contents into information to be applied to an avatar based on tag information that the blogging server 100 receives. Referring to FIG. 4, when receiving a situation tag 35, a preference tag 31, and a profile tag 33 from the mobile terminal 200, the blogging server 100 may extract information from each tag. For example, the blogging server 100 may extract dynamic context 45 from the situation tag 35, static context 43 from the profile tag 33, and user preference 41 from the preference tag 31. The blogging server 100 extracts index terms based on the extracted dynamic context 45, static context 43, and user preference 41. For example, the blogging server 100 may combine the dynamic context 45, the static context 43, and the user preference 41 to search for or recommend contents, for example, a blog, to be provided to a mobile terminal user by the mobile terminal 200.

More specifically, the blogging server 100 may extract information of the current location of the mobile terminal 200 in the course of extracting the dynamic context 45 from the situation tag 35, and determine at which position the mobile terminal 200 is located in the virtual matrix space 15 and if there is location-related contents that can be provided to the mobile terminal 200 at the corresponding location. Also, the blogging server 100 may extract information related to the profile of the mobile terminal user, such as age, gender, and nationality, in the course of extracting the static context 43 from the profile tag 31, and search for contents to be provided in relation with the profile. Furthermore, the blogging server may extract information related to the user preference 41, such as sports and health, from the preference tag 31, and search for the contents according to the preference. The blogging server 100 exploits the static context 43, the dynamic context 45, and the user preference 41 in a combining manner to provide more useful and appropriate contents to the mobile terminal 200. In other words, when receiving pieces of information related to the mobile terminal 200, that is, tag information from the user terminal 400, the blogging server 100 infers the index terms 47 from the tag information for searching for contents or a blog to recommend to the mobile terminal user. The blogging server 100 stores the extracted indexes in an index repository 48, and stores each tag included in the tag information in a tag repository 49. Such management of the blogging server 100 enables a faster and more appropriate search for contents to be provided to a particular mobile terminal 200, and maintains the reliability and accuracy of the corresponding contents.

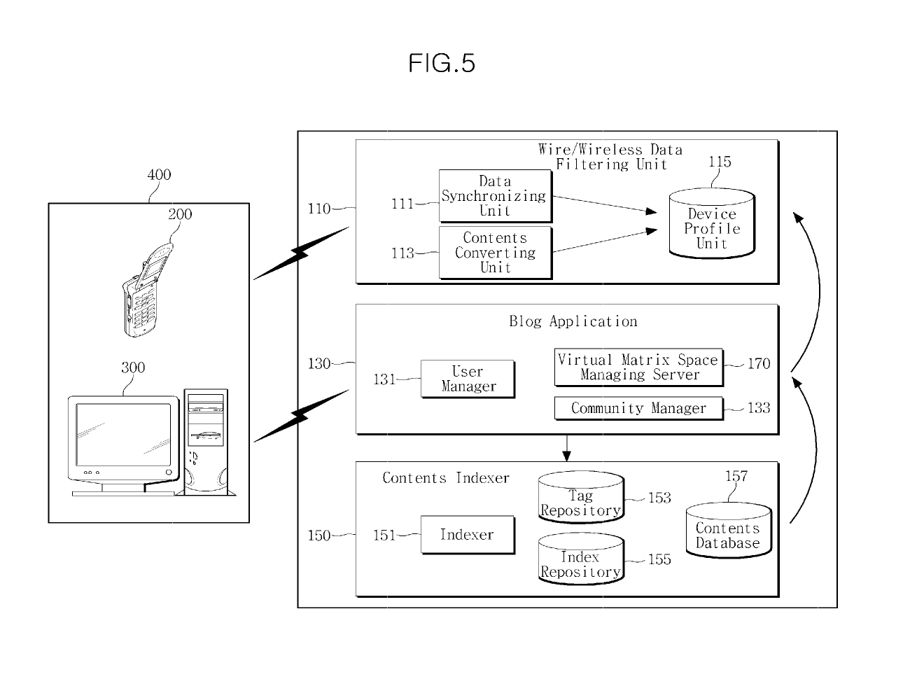

FIG. 5 is an illustration showing a configuration of an exemplary blogging server 100. Referring to FIG. 5, the blogging server 100 includes a wire/wireless data filtering unit 110, a blog application 130, and a contents indexer 150. The blogging server 100 uses the blog application 130 to provide a virtual matrix space 15 to a user terminal 400 including a fixed terminal 300 and a mobile terminal 200. To this end, the blogging server 100 transmits, to the contents indexer 150, tag information collected from the mobile terminal 200 or the fixed terminal 300, which is accessing the virtual matrix space 15, and controls the contents indexer 150 to extract a necessary tag or index from corresponding tag information. Afterwards, the blogging server 100 searches for necessary contents based on the tag or index extracted by the contents indexer 150, transmits the searched contents to the wire/wireless data filtering unit 110 to convert the contents into a format suitable to the mobile 200 terminal and/or the fixed terminal 300 and transmits the converted contents to the user terminal 400 including the mobile terminal 200 and the fixed terminal 300. In this case, the blogging server 100 may collect information for controlling an avatar from the tag information, control a state or facial expressions of each avatar in the virtual matrix space based on the collected information, and transmit the corresponding data to the mobile terminal 200 or to the fixed terminal 300 to control the state or facial expressions of an avatar displayed on each terminal.

The wire/wireless data filtering unit 110 is a device for transmitting contents or data for controlling the avatar to the user terminal 400 in the course of building a wired and wireless communication between the blogging server 100 and the user terminal 400. To this end, the wire/wireless data filtering unit 110 may include a data synchronizing unit 111, a contents converting unit 113, and a device profile unit 115.

The data synchronizing unit 111 is a device for supporting robust communication between the blogging server 100 and the user terminal 400 even with a weak network connection in a wire/wireless interworking environment. That is, the data synchronizing unit 111 may monitor channel status with the user terminal 400, and adjust a network path to maintain the channel status at a constant data transmission speed. In other words, when there occurs channel quality degradation such as an increase of traffic in a channel established between the user terminal 400 and the blogging server 100 due to wire/wireless environment, the data synchronizing unit 111 evaluates channel quality, and searches for a new channel path with a quality above a certain quality threshold to maintain the channel quality based on the new channel path when the current channel quality is below the quality threshold. Moreover, the data synchronizing unit 111 forcefully controls the amount of data traffic transmitted and received to prevent channel cancellation. The data synchronizing unit 111 may maintain the robustness of the channel between the blogging server 100 and the user terminal 400 by use of other various methods and algorithms.

In an environment in which the blogging server 100 and the user terminal 400 are interworked wired and wirelessly, to provide optimal contents to each user terminal 400, the contents converting unit 113 reads a device profile of the user terminal 400 and changes a user interface for formatting contents or outputting an avatar according to the specification of the device based on the device profile. The user terminal 400 accessing the blogging server 100 may be one of various terminals, for example, a mobile terminal or a fixed terminal as described above, and the user terminal 400 varies its data transmission/receipt capability with the device specifications. Accordingly, the contents converting unit 113 collects information about the device profile, such information specifying the data transmission and receipt capability of each user terminal 400, and adjusts the amount of data transmitted to a corresponding user terminal 400 and the user interface based on the collected device profile. In this case, the contents converting unit 113 may adjust a format of transmitted and received contents, the amount of data, and the user interface according to a characteristic of a network connected with the blogging server 100, e.g., a type of a network, a wired or a wireless network, as well as the device profile that is unique characteristics of the user terminal 400.

The device profile unit 115 collects and stores the device profiles of the user terminals 400 and provides the stored device profiles to the contents converting unit 113 such that the contents converting unit 113 can receive appropriate contents from each user terminal 400 and run the received contents. The blogging server 100 may obtain the device profile directly from the user terminal 400, which provides its device profile upon accessing the blogging server 100, or obtains the device profile by requesting the user terminal 400 for information regarding the device profile.

The contents indexer 150 stores various contents to be provided to the user terminal 400 through the virtual matrix space 15, and stores tags and indexes for searching for corresponding contents. The contents indexer 150 may include an indexer 151, a tag repository 153, an index repository 155, and a contents database 157. The indexer 151 extracts index terms indicating contents by automatically analyzing various contents held by the blogging server 100 or provided from another server linked with the blogging server 100. That is, the indexer 151 assigns an index term to each of contents to facilitate classification of the contents provided in the virtual matrix space 15, so that the contents can be recommended to each user terminal 400. To this end, the indexer 151 may assign the index term on the basis of texts or pictures contained in the contents, or extract the index term from a particular text. The tag repository 153 stores tags extracted from the tag information transmitted from the user terminal 400. The index repository 155 stores the index terms extracted by the indexer 151. The contents database 157 stores the contents to be provided to avatars belonging to the virtual matrix space.

The blog application 130 is an application for providing the virtual matrix space 15. The blog application 130 creates a virtual matrix space 15 based on the static reflection information and the dynamic reflection information, and provides the created virtual matrix space 15 to the user terminal 400. The blog application 130 includes a user manager 131, a community manager 133, and a virtual matrix space managing server 170.

The user manager 131 manages the avatars entering the virtual matrix space 15, that is, the user terminals 400 including the mobile terminal 200 and the fixed terminal 300. In other words, when receiving the tag information from each user terminal 400, the user manager 131 loads an avatar corresponding to the tag information to the virtual matrix space, and performs a predetermined operation such as recommending a blog searched based on the tag information to the user terminal 400 corresponding to the loaded avatar.

The community manager 133 manages a community in which the avatar corresponding to the user terminal 400 joins. That is, when the community manager 133 confirms that the user terminal 400 is joining a community based on the tag information from the user terminal 400, the community manager 133 checks the current use status of the corresponding community, and controls necessary operations when uploading contents to the community or downloading contents from the community. Furthermore, when a new community is created by the user terminal 400 based on agreements between the avatars in the virtual matrix space 15, the community manager 133 may perform registration and maintenance of the created community.

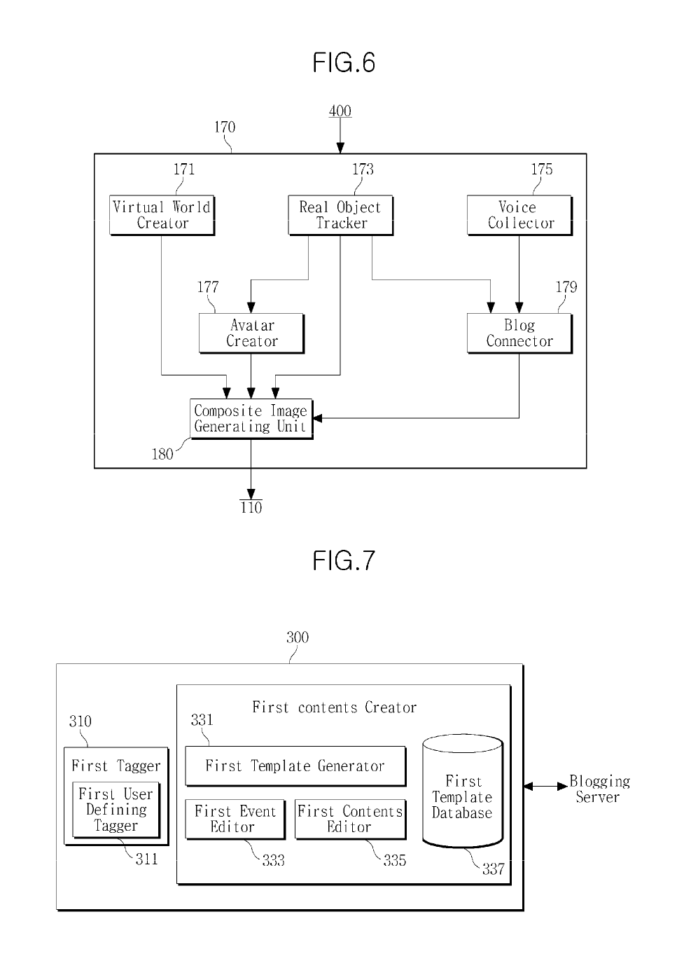

The virtual matrix space managing server 170 provides the user terminal 400 with the virtual matrix space 15 to which the static information is reflected and maintains the virtual matrix space 15, and receives the tag information from the user terminal 400 to extract information necessary for constructing the virtual matrix space 15 from the tag information and applies the extracted information to the virtual matrix space 15. In addition, the virtual matrix space managing server 170 provides the various items of information applied to the virtual matrix space 15 to the wire/wireless data filtering unit 110 to transmit the information to the user terminal 400. The virtual matrix space managing server 170 may include a mirror world creator 171, a real object tracker 173, a voice collector 175, an avatar creator 177, and a composite image generator 180 as shown in FIG. 6.

The mirror world creator 171 reflects the static reflection information corresponding to the real world 11 to create the mirror world 13. To this end, the mirror world creator 171 collects various items of information regarding the landmarks of the real world 11 and creates the mirror world 13 that can be the miniature of the real world 11 based on the collected information.

The real object tracker 173 tracks tag information regarding the movement and location of the user terminal 400 in the real world 11 in real time. That is, the real object tracker 173 collects tag information about the movement and the consequent location of the user terminal 400, especially, the mobile terminal 200, and a status of a user of the mobile terminal 200, and transmits the collected tag information to the avatar creator 177.

The voice collector 175 receives a voice query transmitted from the user terminal 400 for searching for a blog and converts the received voice query into text. Then, the voice collector 175 transmits the converted text to the blog connector 179.

The avatar creator 177 manages the creation of the avatar to enter the virtual matrix space 15 in association with the user manager 131, and supports the conversion of an image of the avatar entering the virtual matrix space 15 based on the tag information received from the real object tracker 173. That is, the avatar creator 177 supports the application of the tag information received from the user terminal 400 to the avatar present in the virtual matrix space 15.

The blog connector 179 searches for a blog to be provided to the user terminal 400 based on the tag information received from the real object tracker 173 and the voice query transmitted from the user terminal 400. When the user terminal 400 registers a new blog, the blog connector 179 may recommend the new blog to a specific user terminal. To this end, the blog connector 179 may extract an index term from the tag information or the voice query transmitted from the user terminal 400, search for at least one of blogs or contents related to avatars present in the virtual matrix space 15 based on the extracted index term, and recommend the found blog or contents to the specific user terminal. Alternatively, the blog connector 179 may register the blog or contents desired by the user terminal 400 in a region of the virtual matrix space 15 indicated by the user terminal 400 or an area arbitrarily designated by the blogging server 100. In addition, the blog connector 179 may receive a text query from the user terminal 400. In this case, the blog connector 179 may extract an index term in the same manner as for the voice query, and search for a blog or contents based on the extracted index term.

The composite image generator 180 combines the mirror world 13, the virtual avatar 5, and the real avatar 3 to create the virtual matrix space 15. That is, the composite image generator 180 generates image information of the virtual avatar 5 corresponding to the fixed terminal 300 accessing the blogging server 100 based on the mirror world 13 created by the mirror world creator 171 and image information of the real avatar 3 corresponding to the mobile terminal 200 to reflect both image information to the mirror world 13. The composite image generator 180 transfers each image information to the wire/wireless data filtering unit 110 to transmit the virtual avatar 5 and the real avatar 3 belonging to the mirror world 13 to the user terminal 400.

As described above, the blogging server 100 provides each user terminal 400 with the mirror world 13 corresponding to a specific area of the real world 11 where the mobile terminal 400 is actually located and a corresponding avatar allowing the user terminal 400 to use various services in the mirror world 13. Additionally, the blogging server 100 collects tag information from the each user terminal 400 to recommend an appropriate blog or contents to the user terminal 400. Accordingly, the blogging server 100 does not operate the user terminal 400 unilaterally in a specific mirror world, but operates each avatar in the virtual matrix space 15 by reflecting the tag information provided by each user terminal 400, so that the blogging server 100 can provide the user terminal 400 with necessary information and support the user terminal 400 to experience a virtual reality similar to the real world 11 through the virtual matrix space 15.

FIG. 7 is a block diagram illustrating an exemplary fixed terminal 300. Referring to FIG. 7, the fixed terminal 300 includes a first tagger 310 and a first contents creator 330. In addition, the fixed terminal 300 may establish a communication channel accessible to a blogging server 100, and further include a communication module for transmitting and receiving data, an input unit for inputting an input signal, an audio processing unit for reproducing and collecting an audio signal, a display unit for outputting various types of information such as an avatar, a blog and contents, a storage unit for storing data to be transmitted and received and information generated by the fixed terminal 300, and a control unit for controlling each of the elements.

The first tagger 310 generates a tag that is meta-information indicating a category where information defined by the user is belonging. To this end, the first tagger 310 may include a first user defining tagger 311 by which a user can define tags in person. The first user defining tagger 311 allows the user to tag various types of information generated by the user, for example, information of particular landmarks in a form of an image, audio or text and properties of the landmarks. The first contents creator 330 is configured for the fixed terminal to create contents easily. To this end, the first contents creator 330 may include a first template generator 331, a first event editor 333, a first contents editor 335, and a first template database 337. The first template generator 331 generates a template to provide a fixed layout for easily producing user contents, e.g., user created contents (UCC), and the first event editor 333 enables the user terminal 400 to independently define matching rules in the voice or text query to be transmitted to the blogging server 100. That is, the first event editor 333 allows the user terminal 400 to search for blogs or contents provided in the virtual matrix space 15 based on its own rules. The first contents editor 335 allows the user terminal 400 to process and edit contents provided in the virtual matrix space 15. The first template database 337 stores the templates for contents.

After entering the virtual matrix space 15, the fixed terminal 300 may transmit a query corresponding to a keyword for a blog or contents to be provided in the virtual matrix space 15, and process and edit the blogs or contents received in the virtual matrix space 15. Also, the fixed terminal 300 generates a tag in a predetermined form, edits the generated tag to generate a blog or contents, and registers the generated blog or contents in a certain region of the virtual matrix space 15.

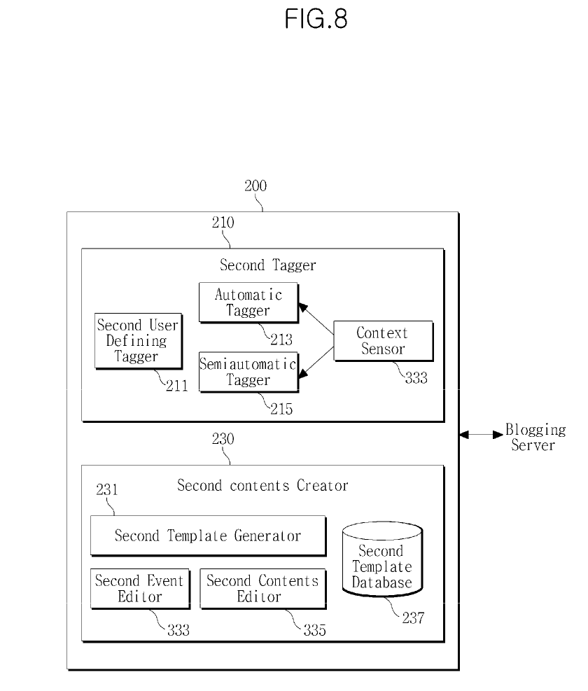

FIG. 8 is a block diagram illustrating an exemplary mobile terminal 200. Referring to FIG. 8, the mobile terminal 200 includes a second tagger 210 and a second contents creator 230. Similarly to the above-described fixed terminal 300, the mobile terminal 200 may establish a communication channel accessible to a blogging server 100, and further include a communication module for transmitting and receiving data, an input unit for inputting an input signal, an audio processing unit for reproducing and collecting an audio signal, a display unit for outputting various types of information such as an avatar, a blog and contents, a storage unit for storing data to be transmitted and received and information generated by the mobile terminal 200, and a control unit for controlling each of the elements.

The second tagger 210 may include a second user defining tagger 211, a context sensor 217, an automatic tagger 213, and a semiautomatic tagger 215. The second user defining tagger 211 may function the same way as the first user defining tagger of the fixed terminal 300.

The context sensor 217 includes a location detecting sensor for measuring the location of the mobile terminal 200, a temperature sensor for detecting ambient temperature around the mobile terminal 200, an acceleration sensor and a gyro sensor for detecting a moving direction of the mobile terminal 200, a body temperature measurement sensor for detecting a body temperature of a mobile terminal user, and the like to collect a variety of sensing information, and converts the sensing information into text. The context sensor 217 provides the automatic tagger 213 and the semiautomatic tagger 215 with the collected sensing information about the current statuses of the mobile terminal 200 and of the user of the mobile terminal 200.

The automatic tagger 213 determines situation tags from the information about, e.g., the location, temperature, and weather, collected by the context sensor 217. The semiautomatic tagger 215 allows a user to adjust the tag generated by the automatic tagger 213. For example, the semiautomatic tagger 215 may request the user for selection to adjust ambiguous tags and tags required the verification of the user. That is, while the location, moving direction, and temperature of the mobile terminal 200, from which the tags are determined by the automatic tagger 213, are obvious information without ambiguity and thus classified based on the tag information generated by the automatic tagger 213, the tag information requiring complex information such as feelings of a user or weather is difficult to be classified and even when classified, the resulting tag information may have very low reliability. Thus, the semiautomatic tagger 215 supports the user to select information and input data for manipulating the information for tag information in person with respect to information that is difficult to be classified based on the information collected by the context sensor 217. As the result, the tag information reliability can be improved.

The second contents creator 230 may include a second template generator 231, a second event editor 233, a second contents editor 235, and a second template database 237. The second template generator 231, the second event editor 233, the second contents editor 235, and the second template database 237 function the same as the respective corresponding units of the above-described fixed terminal 300, and the detailed description will not be reiterated.

As described above, the mobile terminal 200 collects a variety of sensing information using the context sensor 217, and generates various tag information based on the collected sensing information. For example, the mobile terminal 200 uses the context sensor 217 to collect the information of current status of the mobile terminal 200, generates a situational tag based on the collected information and transmits the generated situational tag to the blogging server 100. Then the blogging server 100 determines and operates a facial expression of, a change of direction of, or a gesture of the real avatar 3. The mobile terminal 200 stores the user's profile tag and preference tag in a storage unit, and provides the tags to the blogging server 100 upon accessing the blogging server 100. In response, the blogging server 100 can provide a specific blog or contents to the real avatar 3 present in the virtual matrix space 15 based on the profile tag and the preference tag received from the mobile terminal 200.

Hereinafter, there will be described a procedure 900 for operating a service provided to a mobile terminal 200, in association with operating a real avatar 3 in a virtual matrix space 15 provided by a matrix blogging system 90.

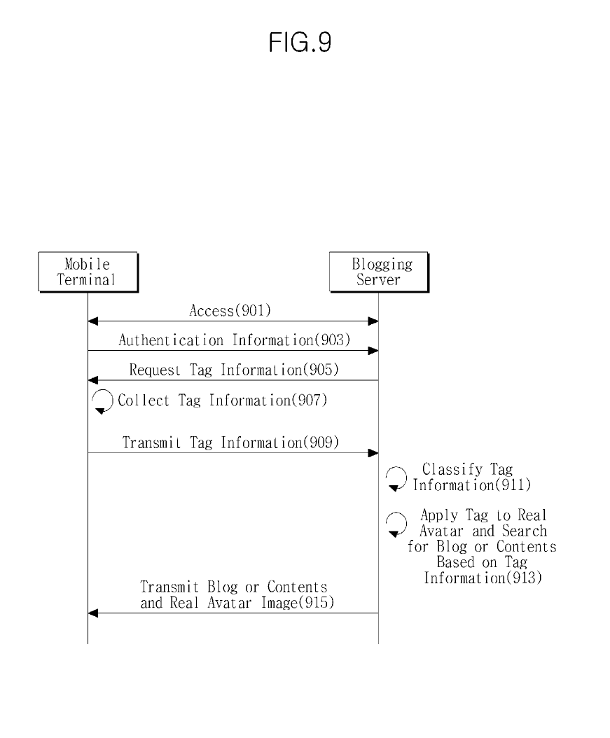

FIG. 9 is a diagram illustrating an exemplary procedure 900 for operating a real avatar 3 and supporting a service based on data transmission/receipt between a blogging server 100 and a mobile terminal 200.

Referring to FIG. 9, to support the matrix blogging service, first, the mobile terminal 200 operates a communication module to access the blogging server 100 in response to an input signal from an input unit (operation 901). Specifically, the mobile terminal 200 operates the communication module to access a mobile communication network 500, and, through the mobile communication network 500, accesses the Internet that the blogging server 100 accesses. The mobile terminal 200 may access the blogging server 100 with authentication by the blogging server 100.

The mobile terminal 200 accessing the blogging server 100 provides the blogging server 100 with unique identification information or authentication information for verifying the unique identification information to enter the virtual matrix space 15 provided by the blogging server 100 (operation 903). To this end, the mobile terminal 200 may previously subscribe to the blogging server 100 and create a real avatar 3 representing the mobile terminal 200. In this procedure, the mobile terminal 200 may present the unique information as subscription information.

If the authentication information provided by the mobile terminal 200 is valid, the blogging server 100 sends a request to the mobile terminal 200 for tag information (operation 905). The tag information may be a situation tag, a profile tag, or a preference tag. The situation tag indicates a situational condition, including location, temperature, humidity, and emotion. That is, the situation tag means factors that can be easily changed in real time with circumstances. Each of the tag information may include sub-items, and each sub-item, e.g., location, has detailed items, e.g., shop, restaurant, airport, theater, office, and station. The profile tag may include age, gender, date of birth, nationality, and the like. That is, the profile tag indicates inherent background factors. The preference tag includes people's interests or hobbies such as music, trip, pet, food, drama, sports, fashion, politics, and school.

The mobile terminal 200 collects the tag information regarding the surroundings of the mobile terminal 200 using a context sensor in response to tag information request from the blogging server 100 (operation 907), and transmits the collected tag information to the blogging server 100 (operation 909). When the blogging server 100 receives the tag information from the mobile terminal 200, classifies and stores the received tag information into information to be applied to the real avatar and keywords for a blog or contents to be recommended to the mobile terminal 200 (operation 911).

The blogging server 100 applies the tag information to the real avatar 3, resulting in changes in a facial expression, a movement, a direction and a setting of the real avatar 3 in the virtual matrix space 15, and also provides the real avatar 3 with a blog or contents found based on the keyword. At this time, the blog or contents to be provided to the real avatar is searched for based on the tag information from the mobile terminal 200, and may be related to the preference, situation, or profile of the mobile terminal user.

Then, the blogging server 100 transmits an image of the virtual matrix space 15 and the real avatar 3 applied to the virtual matrix space 15 and the searched blog or contents to the mobile terminal 200 (operation 915). In this procedure, the blogging server 100 may convert the contents for the image of the virtual matrix space 15 and the real avatar 3 in the virtual matrix space 15 to be displayed with proper size and resolution or adjusts the data transmission speed in consideration of the device profile of the mobile terminal 200 and the communication network condition.

The procedure 900 may be applied to the fixed terminal 300 in a similar way. However, in this case, the fixed terminal 300 may transmit information to a blogging server 100, other than tag information regarding the movement or direction of the fixed terminal 300. Accordingly, the blogging server 100 is enabled to provide a blog or contents to a virtual avatar 5 corresponding to the fixed terminal 300 in the virtual matrix space 15.

As described above, in the matrix blogging service, tag information related to a real-time location of a user terminal 400 and a user of the terminal is received, and the tag information is applied to an avatar corresponding to the user terminal 400 while information to be recommended to the avatar is searched for based on the tag information in a virtual matrix space 15 where the avatar is present.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A matrix blogging service supporting method comprising:
accessing, by a user terminal, a blogging server;
creating, at the blogging server, an avatar corresponding to the user terminal;
operating, at the blogging server, a virtual matrix space including applying the avatar to a mirror world corresponding to a real world where the user terminal is located;
receiving, at the blogging server, tag information from the user terminal;
extracting, at the blogging server, tags including a status, mobility and a direction of the avatar based on the tag information; and
transmitting, at the blogging server, image information corresponding to the virtual matrix space including the avatar to which the tags are applied to the user terminal.

2. The matrix blogging service supporting method of claim 1, wherein the user terminal is at least one of a mobile terminal and a fixed terminal.

3. The matrix blogging service supporting method of claim 2, wherein creating the avatar includes at least one of creating a virtual avatar corresponding to the fixed terminal and creating a real avatar corresponding to the mobile terminal.

4. The matrix blogging service supporting method of claim 3, wherein operating the virtual matrix space comprises:
allowing at least one of the real avatar and the virtual avatar to enter the mirror world; and
operating the entered real avatar or the entered virtual avatar.

5. The matrix blogging service supporting method of claim 1, wherein transmitting the image information to the user terminal comprises:
verifying a device profile of the user terminal;
converting the image information based on conditions of a user interface outputting the image information and the amount and speed of data receivable by the user terminal according to the device profile; and
transmitting the converted image information to the user terminal.

6. The matrix blogging service supporting method of claim 5, wherein transmitting the image information to the user terminal comprises:
checking data processing capability of a communication network between the blogging server and the user terminal; and
converting the image information according to the data processing capability.

7. The matrix blogging service supporting method of claim 1, wherein receiving the tag information comprises at least one of:
receiving profile tag information including at least one of the age, gender, date of birth, and nationality of the user;
receiving situation tag information including at least one of a location and emotion of the user and temperature and humidity around the user terminal; and
receiving preference tag information including at least one of music, a trip, a pet, food, dramas, sports, fashion, politics, and a school.

8. The matrix blogging service supporting method of claim 7, further comprising:
searching for information regarding at least one of a blog or contents to be recommended to the avatar based on at least one of the profile tag information, the situation tag information, and the preference tag information; and
providing the avatar with at least one of the searched information and tags extracted from at least one of the profile tag information, the situation tag information and the preference tag information.

9. The matrix blogging service supporting method of claim 8, wherein searching for the information comprises:
extracting, at the blogging server, an index term from at least one of the profile tag information, the situation tag information, and the preference tag information; and
searching for at least one of a blog information and the contents information that matches the extracted index term from a database in which at least one blog and at least one contents are classified based on index terms.

10. The matrix blogging service supporting method of claim 9, further comprising:
receiving a voice or text query from the user terminal;
extracting an index term from the voice or text query; and
searching for at least one of the blog and the contents using the index term extracted from the audio or text query.

11. A matrix blogging system comprising:
a user terminal configured to access a blogging server through a communication network, collect tag information, and transmit the tag information to a blogging server; and
the blogging server configured to create an avatar corresponding to the user terminal, operate a virtual matrix space by applying the avatar to a mirror world corresponding to a real world where the user terminal is located, extract tags including at least one of a status, mobility and a direction of the avatar from tag information received from the user terminal to apply the tags to the avatar, and transmit image information corresponding to the virtual matrix space including the avatar, to which the tags are applied, to the user terminal.

12. The matrix blogging system of claim 11, wherein the user terminal is at least one of a fixed terminal and a mobile terminal and the blogging server is configured to create at least one of a virtual avatar corresponding to the fixed terminal and a real avatar corresponding to the mobile terminal.

13. The matrix blogging system of claim 11, wherein the blogging server comprises:
a device profile unit configured to verify a device profile of the user terminal;
a contents converting unit configured to convert the image information based on conditions of a user interface outputting the image information and the amount and speed of data receivable by the user terminal according to the device profile; and
a data synchronizing unit configured to transmit the converted image information to the user terminal.

14. The matrix blogging system of claim 11, wherein the user terminal collects at least one of profile tag information, situation tag information and preference tag information, the profile tag information indicates a unique background factor of the user terminal and includes at least one of the age, the gender, the date of birth, and the nationality of the user, the situation tag information can be changed according to a situation which the user faces and includes at least one of a location and emotion of the user and temperature and humidity around the user terminal, and the preference tag information is independent of the time and location of the user terminal and includes at least one of music, a trip, a pet, food, dramas, sports, fashion, politics, and a school.

15. The matrix blogging system of claim 14, wherein the blogging server comprises a virtual matrix space managing server configured to:
search for information regarding at least one of a blog or contents to be recommended to the avatar based on at least one of the profile tag information, the situation tag information, and the preference tag information; and
provide the avatar with at least one of the searched information and tags extracted from at least one of the profile tag information, the situation tag information, and the preference tag information.

16. The matrix blogging system of claim 15, wherein the virtual matrix space managing server comprises:
a real object tracker configured to extract an index term from at least one of the profile tag information, the situation tag information, and the preference tag information; and
a blog connector configured to search for at least one of the blog information and the contents information that corresponds to the extracted index term from a database classifying at least one blog and at least one contents by an index term.

17. The matrix blogging system of claim 16, wherein the virtual matrix space managing server further comprises an audio collector configured to receive an audio or text query from the user terminal and extract an index term from the audio or text query and the blog connector searches for at least one of the blog and the contents using the index term extracted from the audio or text query.
